(19) United States
(12) Patent Application Publication
(10) Pub. No.: US 2017/0199495 A1
(43) Pub. Date: Jul. 13, 2017

(54) THREE-DIMENSIONAL IMAGE CAPTURING APPARATUS AND IMAGE CAPTURING METHOD USING DIGITAL HOLOGRAPHY

(71) Applicant: CANON KABUSHIKI KAISHA, Tokyo (JP)

(72) Inventors: Isao Matsubara, Utsunomiya-shi (JP); Akira Eguchi, Utsunomiya-shi (JP)

(21) Appl. No.: 15/391,051

(22) Filed: Dec. 27, 2016

(30) Foreign Application Priority Data
Jan. 8, 2016 (JP) 2016-002702

(51) Int. Cl. G03H 1/04

(52) U.S. Cl. CPC G03H 1/0443; G03H 2001/0452; G03H 2001/0445; G03H 2001/0473; G03H 2222/20; G03H 2001/045; G03H 2210/30; G03H 2223/12; G03H 2223/24

(57) ABSTRACT

An image capturing apparatus (500) capable of performing three-dimensional tomography of an object by digital holography, includes a splitting element (502) which splits a light beam emitted from a light source into an object light beam and a reference light beam, an illumination system (503) which controls a plurality of object light beams that are generated from the object light beam and that move in directions different from each other to be incident on the object simultaneously, a composite element (507) which causes the plurality of object light beams to interfere with the reference light beam, an image sensor (508) which acquires hologram generated by interference of each of the plurality of light beams with the reference light beam, and a controller (509) which controls the illumination system so that the plurality of object light beams interfere with each other on the image sensor.

### BACKGROUND OF THE INVENTION

Field of the Invention

The present invention relates to a three-dimensional image capturing apparatus using digital holography.

Description of the Related Art

Previously, as one of methods of measuring a distribution of a transparent object, mainly a refractive index distribution, digital holography is known. Here, a basic technology of the digital holography will be described. First, an incident light beam emitted from a light source such as a laser with high coherency is separated into an object light beam and a reference light beam by using a beam splitter or the like. Next, a specimen is disposed on the object light beam so that only the object light beam passes through the specimen. Then, the object light beam and the reference light beam are combined, i.e., interfere with each other, by using the beam splitter or the like, and an interference fringe that is generated by interference between the object light beam and the reference light beam is recorded by a digital sensor. Finally, the distribution of the transparent object, for example a phase distribution is calculated by using a calculator based on the recorded information.

The digital holography has mainly two methods of an Off-Axis method and a phase shift method. The Off-Axis method can calculate a phase based on a single hologram, but it is necessary to care about a pitch of the interference fringe and the like. The phase shift method can fully utilize NA of an optical system, but it is necessary to photograph at least three holograms in order to calculate the phase. Among these methods, the Off-Axis method where the number of photographing times is reduced is commonly used for requiring a photography speed. U.S. Pat. No. 6,078,392 discloses a digital holography technology based on the Off-Axis method.

Recently, as one of methods of photographing the transparent object three-dimensionally, the digital holography is applied. As a unit (multiplexing method) of obtaining information relating to a depth direction, i.e., direction along an optical axis, there are mainly angle multiplexing and wavelength multiplexing. The angle multiplexing is a method of sequentially illuminating object light beams with different incident angles to calculate three-dimensional information based on the information for each incident angle. The wavelength multiplexing is a method of using object light beams with different wavelengths to calculate the three-dimensional information based on information for each wavelength. In order to obtain a high-quality three-dimensional image, the angle multiplexing of these multiplexing methods is commonly used.

Hereinafter, a method of photographing the transparent object by using the angle multiplexing three-dimensionally will be described. In the digital holography described above, an incident angle of the object light beam with respect to a specimen is changed, and interference fringes with respect to a plurality of angles are recorded. It is possible to change the angle of the object light beam with respect to the specimen by changing an angle of a galvanometer mirror that is disposed on a conjugate plane of the specimen. Finally, the distribution of the transparent object, for example the refractive index distribution, is calculated by a calculator based on the information for each recorded angle. US Patent Application Publication No. 2009/125242 discloses a method of photographing the transparent object three-dimensionally by the angle multiplexing.

In order to obtain a high-quality reproduced image in the method of photographing the transparent object three-dimensionally by the angle multiplexing, a large number of photographing times is required. Specifically, the number of photographing times around 100 to 150 times is required, and US Patent Application Publication No. 2009/125242 discloses the number of photographing times around 100 times. In order to sequentially perform such photography, a long photographing time is required. In the method of US Patent Application Publication No. 2009/125242, photographing a moving object is achieved with a small number of photographing pixels to reduce the photographing time per one shot. However, in order to solve a common problem that increases the number of photographing pixels to widen a photographing area, the number of photographing times is a problem to be solved.

If a configuration where a plurality of object light beams are incident is adopted so as to reduce the number of photographing times, the object light beams interfere with each other and accordingly the configuration does not work simply. On the other hand, it is considered that the interference of the object light beams is avoided by the wavelength multiplexing. However, the wavelength multiplexing needs light sources whose number corresponds to the number of images for overlap photographing, and thus a system is complicated. Although it is possible to avoid the interference of the object light beams by polarization multiplexing, the polarization multiplexing only has two degrees of freedom at most for the polarization up, and accordingly there is the upper limit for the multiplexing. In addition, it is necessary to prepare an element for controlling the polarization of each object light beam, add a polarizer to a sensor, and prepare two sensors, and thus the system is complicated.

### SUMMARY OF THE INVENTION

The present invention provides an image capturing apparatus and an image capturing method which are capable of acquiring highly-accurate three-dimensional data with a simple configuration by a small number of photographing times.

An image capturing apparatus as one aspect of the present invention is capable of performing three-dimensional tomography of an object by digital holography, and includes a splitting element configured to split a light beam emitted from a light source into an object light beam and a reference light beam, an illumination system configured to control a plurality of object light beams that are generated from the object light beam and that move in directions different from each other to be incident on the object simultaneously, a composite element configured to cause the plurality of object light beams to interfere with the reference light beam, an image sensor configured to acquire hologram generated by interference of each of the plurality of light beams with the reference light beam, and a controller configured to control the illumination system so that the plurality of object light beams interfere with each other on the image sensor.

An image capturing method as another aspect of the present invention is capable of performing three-dimensional tomography of an object by digital holography, and the method includes the steps of splitting a light beam emitted from a light source into an object light beam and a reference light beam, controlling a plurality of object light beams that are generated from the object light beam and that move in directions different from each other to be incident on the object simultaneously, combining the plurality of object light beams with the reference light beam, and acquiring hologram generated by interference of each of the plurality of light beams with the reference light beam, and the step of controlling the plurality of object light beams to be incident on the object simultaneously includes controlling the plurality of object light beams to interfere with each other on an image sensor.

Further features of the present invention will become apparent from the following description of exemplary embodiments with reference to the attached drawings.

### BRIEF DESCRIPTION OF THE DRAWINGS

FIG. 1 is a schematic diagram of an image capturing apparatus in each embodiment.

FIGS. 2A to 2H are explanatory diagrams of calculation of a reproduced image of an angle-multiplexed hologram in each embodiment.

FIGS. 3A to 3D are explanatory diagrams of simultaneous incidence of a plurality of object light beams that interfere with each other in each embodiment.

FIG. 4A is a schematic diagram of an image capturing apparatus in each embodiment.

FIGS. 4B to 4E are explanatory diagrams of spectra in each embodiment.

FIGS. 5A to 5G are explanatory diagrams of three object light beams that are simultaneously incident on a specimen in Embodiment 1.

FIGS. 6A and 6B are cross-sectional views of reproduced images in Embodiment 1.

FIG. 7 is an explanatory diagram of an azimuth angle in Embodiment 2.

FIGS. 8A to 8G are explanatory diagrams of three object light beams that are simultaneously incident on a specimen in Embodiment 2.

FIGS. 9A and 9B are cross-sectional views of reproduced images in Embodiment 2.

FIGS. 10A to 10G are explanatory diagrams of six object light beams that are simultaneously incident on a specimen in Embodiment 3.

FIGS. 11A and 11B are cross-sectional views of reproduced images in Embodiment 3.

FIGS. 12A and 12B are explanatory diagrams of an azimuth angle in Embodiment 3.

### DESCRIPTION OF THE EMBODIMENTS

Exemplary embodiments of the present invention will be described below with reference to the accompanied drawings. In each of the drawings, the same elements will be denoted by the same reference numerals and the duplicate descriptions thereof will be omitted.

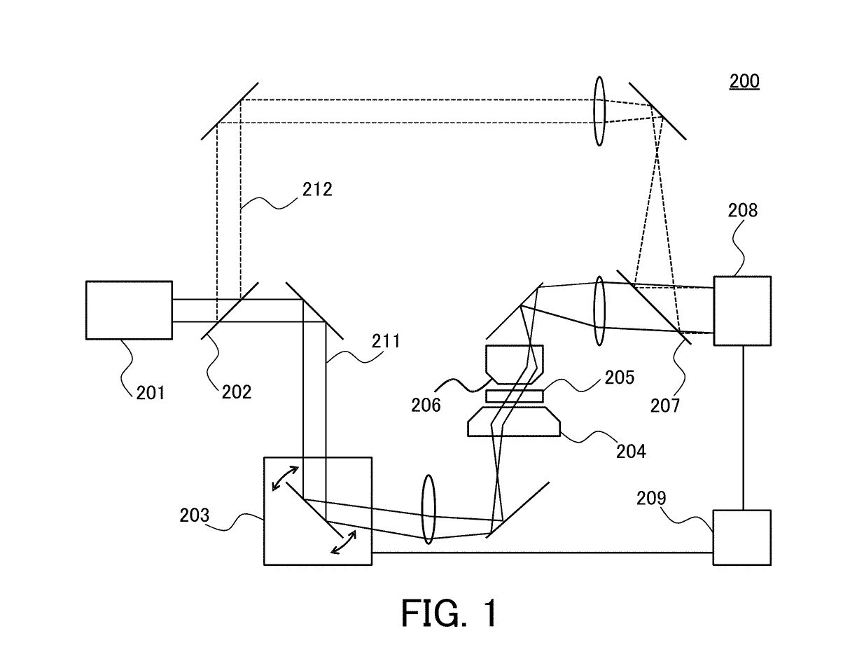

First, referring to FIG. 1, a basic configuration of an image capturing apparatus which is capable of performing three-dimensional tomography of a transparent object (object or specimen) by digital holography will be described. FIG. 1 is a schematic diagram of an image capturing apparatus 200 using the digital holography by angle multiplexing. The image capturing apparatus 200 of this embodiment performs the three-dimensional tomography of the object by using the digital holography by an Off-Axis method.

In FIG. 1, reference numeral 201 denotes a light source such a laser with high coherency, and reference numeral 202 denotes a beam splitter (splitting element). Reference numeral 211 denotes an object light beam, and reference numeral 212 denotes a reference light beam. Reference numeral 203 denotes a galvanometer mirror (galvano mirror), reference numeral 204 denotes a condenser lens, reference numeral 205 denotes a specimen (object), and reference numeral 206 denotes an objective lens. Reference numeral 207 denotes a beam splitter (composite element), and reference numeral 208 denotes a digital sensor (image sensor such as a CMOS sensor). Reference numeral 209 denotes a controller (control unit), and it controls each of units including the galvanometer mirror 203 and the digital sensor 208 of the image capturing apparatus 200. As described above, the image capturing apparatus 200 changes an incident angle of the object light beam 211 on the specimen 205, and accordingly it can record interference patterns (interference fringes) corresponding to a plurality of angles. An angle of the object light beam 211 on the specimen 205 can be changed by adjusting an angle of the galvanometer mirror 203 disposed on a conjugate plane of the specimen 205.

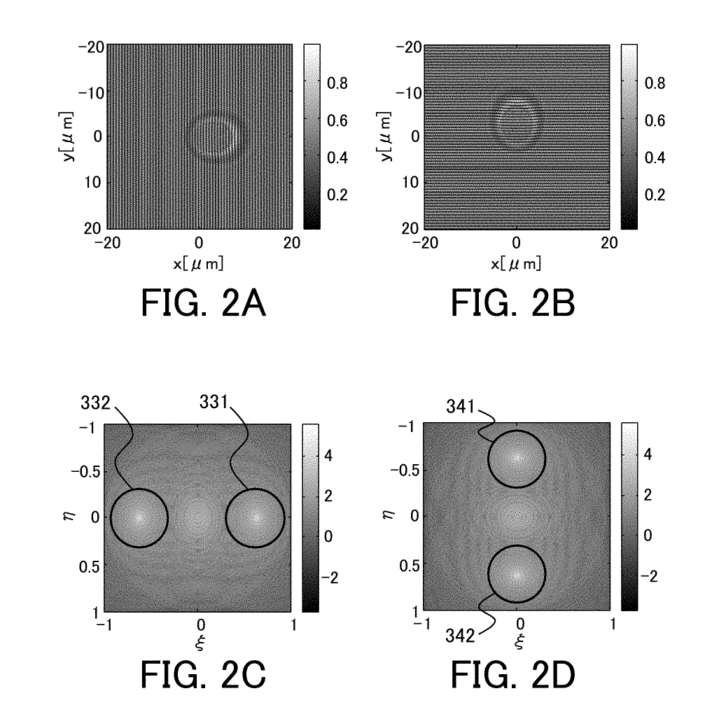

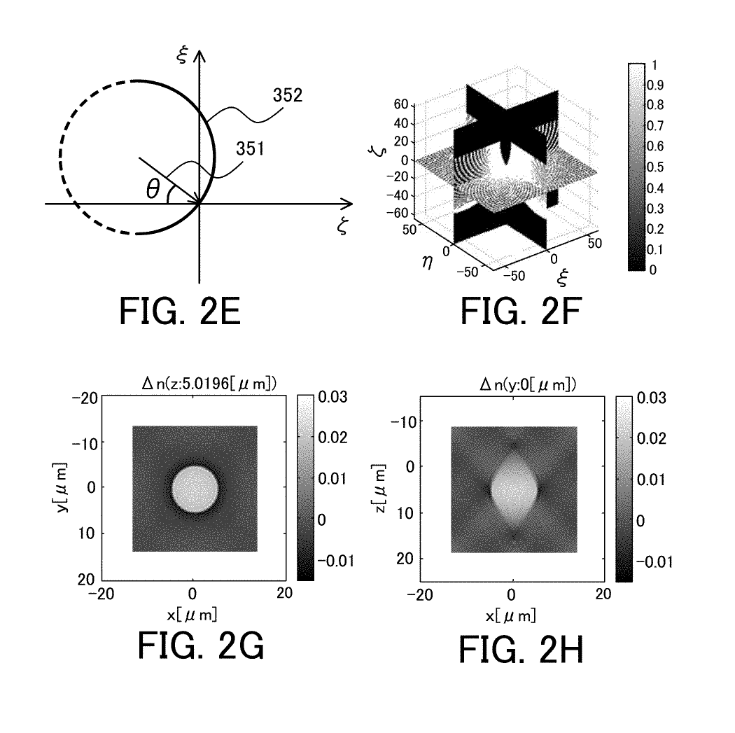

Next, referring to FIGS. 2A to 2H, an outline of calculation of a reproduced image of angle-multiplexed hologram will be described. FIGS. 2A to 2H are explanatory diagrams of the calculation of the reproduced image of the angle-multiplexed hologram. FIGS. 2A and 2B is holograms obtained by photographing the specimen 205 where polystyrene beads having a refractive index of 1.597 and a diameter of 10 μm are immersed in oil. In this embodiment, a refractive index of the oil is 1.575.

An angle of a beam in an object that is determined depending on an incident angle is defined by an angle with respect to an optical axis and an azimuth angle (θ,φ). The upper limit of θ is determined by NA=n·sin θ. Symbol NA denotes a NA (numerical aperture), and symbol n denotes a refractive index of oil of the object 205. When the NA is 1.4, the upper limit of θ is 62.7 degrees, and accordingly a range of θ is from 0 to 62.7 degrees. A range of φ is from 0 to 360 degrees. In this embodiment, θ is set to 34 degrees with sufficient margin. FIGS. 2A and 2B correspond to beam angles (34,0) and (34,90) degrees, respectively. In this embodiment, the reference light beam 212 travels along the optical axis. This spectrum is a distribution on a frequency space that is obtained by the Fourier transform of a hologram.

FIGS. 2C and 2D are diagrams of absolute values of logarithmic expressions of respective spectra corresponding to FIGS. 2A and 2B. Reference numerals 331 and 341 are real image spectra of an object, and the real image spectra 331 and 341 are extracted to perform the inverse Fourier transform, and thus an electric field on an imaging plane can be calculated. Reference numerals 332 and 342 are virtual image spectra of the object. In order to calculate a three-dimensional image, if it is assumed that the first-order Born approximation can be applied, the extracted data of the real image spectra are attached to the Ewald sphere while peaks of the spectra are located on an origin of a coordinate. If it is assumed that the Rytov approximation can be applied, the logarithm of the electric field calculated by the inverse Fourier transform is obtained, the data of the spectra are attached to the Ewald sphere. However, this embodiment is not limited thereto and other methods of calculation can also be applied.

FIG. 2E is a wave vector 351 and an Ewald sphere 352 which correspond to the beam angle (34,0). Specifically, data of the real image spectrum 331 are attached to the Ewald sphere 352. While the Ewald sphere 352 are depicted with a curved line, in reality it is a surface of a sphere that spreads also in a depth direction. FIG. 2F is a diagram of illustrating Ewald spheres that correspond to a number of angles. By attaching spectra at all angles by the angle multiplexing to the Ewald spheres, three-dimensional spectra can be obtained. Then, the inverse Fourier transform is performed on the three-dimensional spectra, and accordingly a three-dimensional reproduced image can be obtained. FIGS. 2G and 2H illustrate an XY cross-sectional view and an XZ cross-sectional view of the three-dimensional reproduced image, respectively.

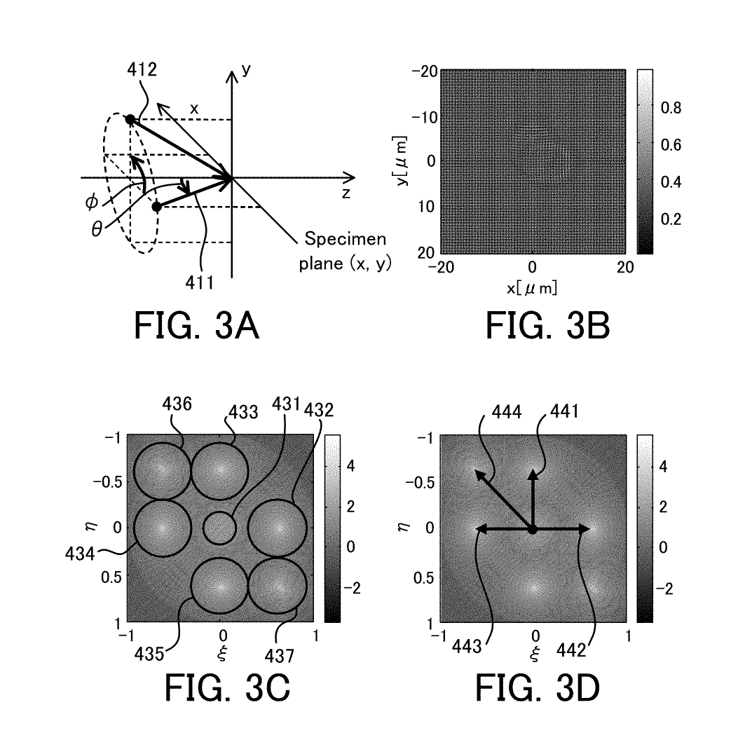

A basic concept of the image capturing apparatus 200 in this embodiment is to reduce the number of photographing times by acquiring a plurality of real image spectra while a plurality of object light beams are simultaneously incident. FIGS. 3A to 3D are explanatory diagrams of the simultaneous incidence of a plurality of object light beams that interfere with each other. The term “interfere with each other” means that the plurality of object light beams interfere on the sensor (digital sensor 208). For example, although even in polarization multiplexing, the interference occurs when polarization states of differently-polarized object light beams are changed, this phenomenon is different from the interference described in this embodiment. The interference in this embodiment corresponds to the interference on the sensor and it means that the interference occurs even when an additional procedure such as changing the polarization states is not performed. Although in a multiple wavelength, interference patterns can be obtained if the photography (tomography) is performed in a time in which light travels by a wavelength, the interference in this embodiment means that interference patterns can be obtained even if the photography is performed for example in 1/10000 sec to 1/10 sec.

FIG. 3A illustrates two object light beams that are simultaneously incident on a specimen plane (surface of the specimen 205). In this embodiment, the object light beam at (34,0) degrees in the specimen is referred to as a first object light beam 411, and the object light beam at (34, 90) degrees in the specimen is referred to as a second object light beam 412. The reference light beam travels along the optical axis. FIG. 3B is a hologram obtained when the two object light beams that interfere with each other are simultaneously incident. FIG. 3C illustrates a spectrum of the hologram of FIG. 3B. This spectrum includes a virtual image spectrum 432 of a zeroth order light beam 431 and the first object light beam 411 of the hologram and a real image spectrum 433 of the second object light beam 412, a virtual image spectrum 434 of the first object light beam 411, and a virtual image spectrum 435 of the second object light beam 412. Furthermore, this spectrum includes a crosstalk 436 of the virtual image spectrum of the first object light beam 411 and the real image spectrum of the second object light beam 412 and a crosstalk 437 of the real image spectrum of the first object light beam 411 and the virtual image spectrum of the second object light beam 412. In order to avoid occurrence of the crosstalk caused by the interference of these object light beams, there are methods of adopting the polarization multiplexing where polarization directions of the object light beams are different from each other and the wavelength multiplexing where wavelengths of the object light beams are different from each other. However, differently from these methods, this embodiment control a position of the crosstalk to perform the multiplexing by the object light beams that interfere with each other. The zeroth order light beam 431 of the hologram corresponds to the peak that exists on the origin that is obtained by performing the Fourier transform of the hologram.

Next, each spectrum will be described referring to expressions. In expression (1) below, symbols E_{O1}, E_{O2}, and E_{R} denote electric fields of the first object light beam, the second object light beam, and the reference light beam, respectively. Symbols A_{O1}, A_{O2} and A_{R} denote amplitudes of the electric fields of the first object light beam, the second object light beam, and the reference light beam, respectively. Symbols ψ₁ and ψ₂ denote phases of the first object light beam and the second object light beam, respectively. Symbols α and β are values calculated based on the beam angle θ in the object.

E_{O1}(x,y)=A_{O1}(x,y)exp[iψ₁(x,y)+2πixα]

E_{O2}(x,y)=A_{O2}(x,y)exp[iψ₂(x,y)+2πiyβ]

E_{R}(x,y)=2A_{R} (1)

As represented by expression (2) below, the hologram can be calculated as the square of an absolute value of a sum of the three electric fields described above.

$${\vert {E}_{O 1} + {E}_{O 2} + {E}_{R} \vert}^{2} = 4 {A}_{R}^{2} + {A}_{O 1}^{2} ( x , y ) + {A}_{O 2}^{2} ( x , y ) + 2 {A}_{R} {A}_{O 1} ( x , y ) exp [ i {ψ}_{1} + 2 π ix α ] + 2 {A}_{R} {A}_{O 2} ( x , y ) exp [ i {ψ}_{2} + 2 π iy β ] + 2 {A}_{R} {A}_{O 1} ( x , y ) exp [ - i {ψ}_{1} - 2 π ix α ] + 2 {A}_{R} {A}_{O 2} ( x , y ) exp [ - i {ψ}_{2} - 2 π iy β ] + {A}_{O 1} ( x , y ) {A}_{O 2} ( x , y ) exp [ - i {ψ}_{1} - 2 π ix α + i {ψ}_{2} + 2 π iy β ] + {A}_{O 1} ( x , y ) {A}_{O 2} ( x , y ) exp [ i {ψ}_{1} + 2 π ix α - i {ψ}_{2} - 2 π iy β ] \qquad ( 2 )$$

The spectrum of the hologram can be calculated by the Fourier transform of expression (2), and it is represented by expression (3) below.

$$\int {\vert {E}_{O 1} + {E}_{O 2} + {E}_{R} \vert}^{2} exp [ - 2 π i ( x ξ + y η ) ] dxdy = \{ 8 π {A}_{R}^{2} δ ( ξ ) δ ( η ) + 2 π {\tilde{E}}_{O 1} ( ξ , π ) ⋆ {\tilde{E}}_{O 1} ( ξ , η ) + 2 π {\tilde{E}}_{O 2} ( ξ , η ) ⋆ {\tilde{E}}_{O 2} ( ξ , η ) \} + 4 π {A}_{R} {\tilde{E}}_{O 1} ( ξ - α , η ) + 4 π {A}_{R} {\tilde{E}}_{O 2} ( ξ , η - β ) + 4 {πA}_{R} {{E}^{\overline{\sim}}}_{O 1} ( - ξ + α , - η ) + 4 π {A}_{R} {{E}^{\overline{\sim}}}_{O 2} ( - ξ , - η + β ) + 2 π {\tilde{E}}_{O 1} ⋆ {\tilde{E}}_{O 2} ( ξ + α , η - β ) + 2 π {{E}^{\overline{\sim}}}_{O 1} ⋆ {{E}^{\overline{\sim}}}_{O 2} ( - ξ - α , - η + β ) \qquad ( 3 )$$

In expression (3), symbol “-” as a superscript represents a complex conjugate, and an operator “*” represents cross-correlation that is represented by expression (5) below. Based on the electric field represented by expression (1), the spectrum of terms where the influence of the inclination is eliminated is represented by expression (4) below. In expression (4), symbol FT denotes the Fourier transform, and symbol (ξ,η) denotes a position of the spectrum in a frequency space f.

\tilde{E}_{O1}(ξ,η)=FT[A_{O1}(x,y)exp[iψ₁(x,y)

[symbol]

\tilde{E}_{O2}(ξ,η)=FT[A_{O2}(x,y)exp[iψ₂(x,y)

[symbol]

\tilde{E}_{R}(ξ,η)=FT[E_{R}(x,y)] (4)

f*g(x,y)=∫_{-∞}^{∞}f(x′,y′)g̅(x′−x,y′−y)dxdy (5)

On the right side of expression (3), the first term, the second term, and the third term correspond to the zeroth order light beam 431, the real image spectrum 432 of the first object light beam 411, and the real image spectrum 433 of the second object light beam 412, respectively. The fourth term and the fifth term correspond to the virtual image spectrum 434 of the first object light beam 411 and the virtual image spectrum 435 of the second object light beam 412, respectively. The sixth term and the seventh term correspond to the crosstalk 436 of the virtual image spectrum of the first object light beam 411 and the real image spectrum of the second object light beam 412, and the crosstalk 437 of the real image spectrum of the first object light beam 411 and the virtual image spectrum of the second object light beam 412, respectively.

Hereinafter, the crosstalk will be described in detail. Positions of the spectrum of the crosstalk are represented by (ξ6,η6)=(−α,β) for the sixth term and (ξ7,η7)=(α,−β) for the seventh term. The position of ξ is determined depending on the first object light beam 411, and the position of η is determined depending on the second object light beam 412. On the other hand, the positions of the real image spectra of the first object light beam 411 and the second object light beam 412 are represented by (ξ1,η1)=(α,0) and (ξ2,η2)=(0,β), respectively. Accordingly, the positions of the crosstalk for the sixth term and for the seventh term can be described as (ξ6,η6)=(ξ1,−η2) and (ξ7,η7)=(−ξ2,η1), respectively. FIG. 3D is a diagram of illustrating a position vector of each spectrum. The position of the crosstalk can be determined based on a vector sum 444 of a position vector 441 of the real image spectrum of an object light beam and an inverse vector 443 of a position vector 442 of the real image spectrum of other object light beams (i.e., vector sum of the position vector 441 and the inverse vector 443).

This conclusion will be generalized in a case where N object light beams are incident. In this case, the hologram is represented by expression (6) below.

$${\vert {\sum }_{j = 1}^{N} {E}_{Oj} ( x , y ) + {E}_{R} ( x , y ) \vert}^{2} = {N}^{2} {A}_{R}^{2} + {\sum }_{j = 1}^{N} {\vert {E}_{Oj} ( x , y ) \vert}^{2} + {NA}_{R} {\sum }_{j = 1}^{N} {E}_{Oj} ( x , y ) + {NA}_{R} {\sum }_{j = 1}^{N} {E}_{Oj}^{*} ( x , y ) + {\sum }_{j = 1}^{N} {\sum }_{{j}^{′} \neq j}^{N} {E}_{Oj} ( x , y ) {E}_{{Oj}^{′}}^{*} ( x , y ) + {\sum }_{j = 1}^{N} {\sum }_{{j}^{′} \neq j}^{N} {E}_{Oj}^{*} ( x , y ) {E}_{{Oj}^{′}} ( x , y ) \qquad ( 6 )$$

The spectrum of this hologram is obtained by the Fourier transform of expression (6), and it is represented by expression (7) below.

$$\int {\vert {\sum }_{j = 1}^{N} {E}_{Oj} + {E}_{R} \vert}^{2} exp [ - 2 π i ( x ξ + y η ) ] dxdy = 2 π {N}^{2} {A}_{R}^{2} δ ( ξ ) δ ( η ) + 2 π {\sum }_{j = 1}^{N} {\tilde{E}}_{Oj} ( ξ , η ) ⋆ {\tilde{E}}_{Oj} ( ξ , η ) + 2 π {NA}_{R} {\sum }_{j = 1}^{N} {\tilde{E}}_{Oj} ( ξ - {α}_{j} , η - {β}_{j} ) + 2 π {NA}_{R} {\sum }_{j = 1}^{N} {\tilde{E}}_{Oj}^{*} ( - ( ξ - {α}_{j} ) , - ( η - {β}_{j} ) ) + {\sum }_{j = 1}^{N} {\tilde{E}}_{Oj} ⋆ {\sum }_{{j}^{′} \neq 1}^{N} {\tilde{E}}_{{Oj}^{′}} ( ξ + {α}_{j} - {α}_{{j}^{′}} , η + {β}_{j} - {β}_{{j}^{′}} ) + {\sum }_{j = 1}^{N} {\tilde{E}}_{Oj}^{*} ⋆ {\sum }_{{j}^{′} \neq j}^{N} {\tilde{E}}_{{Oj}^{′}}^{*} ( - ( ξ + {α}_{j} - {α}_{{j}^{′}} ) , - ( η + {β}_{j} - {β}_{{j}^{′}} ) ) \qquad ( 7 )$$

In this embodiment, a region where the real image spectrum has a value is represented by S(ξ,η) (represented by S (f) when the special frequency is denoted by f). In other words, a function where its value indicates 1 when ξ and η satisfying expression (8) below and the value indicates 0 in other cases is defined as S(ξ,η).

$$\vert {\sum }_{j = 1}^{N} {\tilde{E}}_{Oj} ( ξ - {α}_{j} , η - {β}_{j} ) \vert > 0 \qquad ( 8 )$$

In this case, a region where the virtual image spectrum has a value is represented by S(−ξ,−η) according to the fourth term, and a region where the spectrum of the crosstalk has a value is represented by S(ι,η)*S(ξ,η) according to the fifth and sixth terms. In other words, it corresponds to autocorrelation of S(ξ,η). In order to extract the real image spectrum, it is desirable that the real image spectrum is separated from each of the virtual image spectrum and the spectrum of the crosstalk. In other words, it is desirable that a region where both of S(ξ,η) and S(ξ,η)*S(ξ,η) indicate values other than zero does not exist (i.e., a solution that simultaneously satisfies conditions of |S(f)|>0 and |S(f)*S(f)|>0 (f: spatial frequency, *: cross-correlation) does not exist). In order to achieve this, it is necessary that at least the zeroth order light component of the real image spectrum and the spectrum of the crosstalk occurring due to the component should not overlap with each other. The zeroth order light component of the real image spectrum is a real image spectrum of (ξ1,η1)=(α,0) or (ξ2,η2)=(0,α), and it corresponds to a spectrum of the object light beam that travels in a straight line from a specimen. Accordingly, S(ξ, η) is redefined as a region where the zeroth order light component of the real image spectrum occurs. In other words, S(ξ,η) is defined as represented by expression (9) below.

$$S ( ξ , η ) = {\sum }_{j = 1}^{N} δ ( ξ - {α}_{j} , η - {β}_{j} ) \qquad ( 9 )$$

The object light beam may be incident so that the region where both of S(ξ,η) and S(ξ,η)*S(ξ,η) indicate values other than zero does not exist.

In the above description, the case where all the object light beams interfere with the reference light beam is considered, but this embodiment is not limited thereto. The object light beam and the reference light beam can be prepared by splitting a plurality of light beams which do not have coherency, and then they can be controlled to interfere on a sensor surface to photograph overlaid hologram.

Hereinafter, a case where M light sources that do not have coherency exist will be considered. Nm object light beams that are obtained by splitting the m-th (m: 1 to M) light source and the reference light beam are denoted by E_{Omj} and E_{Rm}, respectively. These are controlled to interfere on the sensor surface to acquire the hologram. In this case, the strength of the hologram is represented by expression (10) below.

$${\vert {\sum }_{j = 1}^{{N}_{1}} {E}_{O 1 j} ( x , y ) + {E}_{R 1} ( x , y ) \vert}^{2} + {\vert {\sum }_{j = 1}^{{N}_{2}} {E}_{O 2 j} ( x , y ) + {E}_{R 2} ( x , y ) \vert}^{2} + … + {\vert {\sum }_{j = 1}^{{N}_{M}} {E}_{OMj} ( x , y ) + {E}_{RM} ( x , y ) \vert}^{2} \qquad ( 10 )$$

In order to extract the real image spectrum, it is desirable that the real image spectrum is separated from each of the virtual image spectrum, the spectrum of the crosstalk, and the real image spectrum obtained from another light source. The photographed overlaid hologram is represented as linear combination of the holograms obtained by each light source, and accordingly the above consideration on each term can be adopted independently. In other words, a region where the zeroth order light component of the real image spectrum obtained from the m-th light source occurs is denoted by Sm(ξ,η). In this case, it is desired that both of S(ξ,η) and Sm′(ξ,η), both of Sm(ξ,η) and Sm′(ξ,η)*Sm′(ξ,η), and both of Sm(ξ,η) and Sm′(−ξ,−η) indicate values other than zero does not exist. As a result, the plurality of real image spectrum can be extracted. The plurality of light beams that do not have coherency can be prepared by various methods. For example, there are light beams with different wavelengths or light beams with polarizations orthogonal to each other.

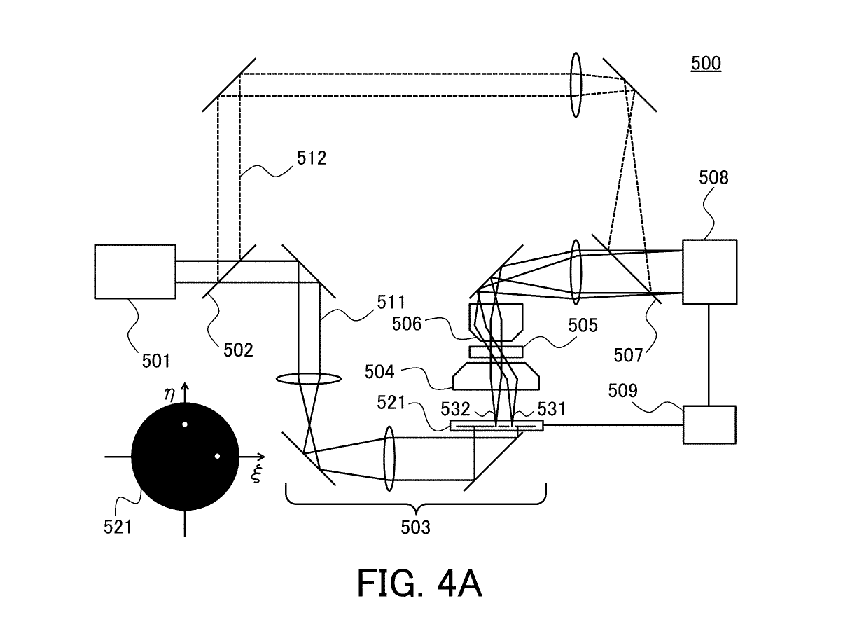

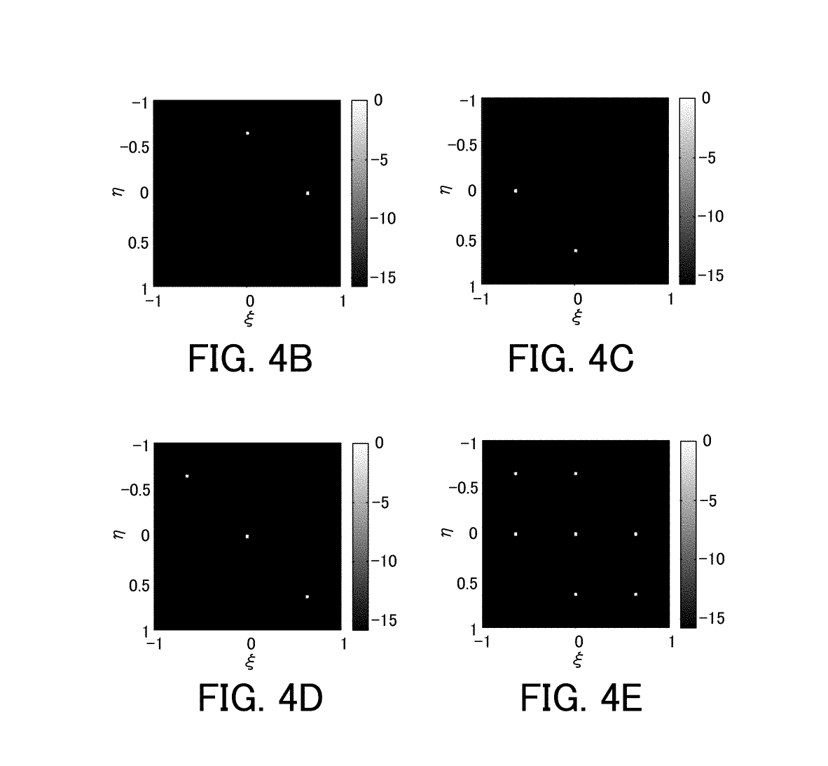

Next, referring to FIG. 4A, an outline of an image capturing apparatus which is capable of acquiring three-dimensional data (which is capable of performing three-dimensional tomography of a specimen) while a plurality of object light beams are simultaneously incident on the specimen will be described. FIG. 4A is a schematic diagram of an image capturing apparatus 500 (image capturing apparatus using the digital holography) which is capable of controlling the plurality of object light beams to be incident on the specimen simultaneously.

In FIG. 4A, a situation where a light beam emitted from a light source is separated into two object light beams and a reference light beam is illustrated. A beam splitter 502 (splitting element) splits the light (incident light) emitted from a light source 501 such as a laser with high coherency into an object light beam 511 and a reference light beam 512. The image capturing apparatus 500 includes an illumination system 503 (optical system) configured so that a plurality of object light beams are simultaneously incident on a specimen. In this embodiment, the illumination system 503 includes an aperture stop 521 and a condenser lens 504, but it is not limited thereto. The illumination system 503 is configured so that the plurality of object light beams that are generated from an object light beam and that travel in directions different from each other are simultaneously incident on a specimen 505. The aperture stop 521 forms an illumination shape. According to the aperture stop 521, the plurality of object light beams in desired combinations can be formed. In this embodiment, the illumination system 503 (aperture stop 521) separates the object light beam 511 into a first object light beam 531 and a second object light beam 532. A controller 509 (control unit) controls each of units such as the aperture stop 521 (illumination system 503) and a digital sensor 508 in the image capturing apparatus 500. The controller 509 controls the aperture stop 521 so that the plurality of object light beams interfere with each other on the digital sensor 508 (on the digital sensor 508) described above. Preferably, as described above, the controller 509 controls a position of the crosstalk that occurs due to the interference of the plurality of object light beams.

Subsequently, the specimen 505 (object) is disposed on the plurality of object light beams (the first object light beam 531 and the second object light beam 532) so that only the plurality of object light beams pass through the specimen 505. In order to increase an angle of the beam with respect to the optical axis in the specimen, the condenser lens 504 and an objective lens 506 are disposed. Furthermore, the condenser lens 504 and the objective lens 506 are disposed in front of and behind the specimen 505, respectively, so that the angle of the beam in the specimen can be set to be large. A beam splitter 507 (composite element) combines each of the plurality of object light beams (the first object light beam 531 and the second object light beam 532) with the reference light beam 512, that is, it causes each of the plurality of object light beams to interfere with the reference light beam. The digital sensor 508 (image sensor such as a CMOS sensor) records (acquires) an interference fringe (hologram) that is generated by interference of each of the object light beams and the reference light beam. As described above, the image capturing apparatus 500 changes the plurality of object light beams with respect to the specimen 505 so that the interference fringes with respect to a plurality of angles can be recorded.

The image capturing apparatus 500 does not need a mechanism for preventing the interference of the plurality of object light beams, such as laser optical sources whose number corresponds to the number of overlaid images, a unit for changing the wavelength of the incident light, and a polarizer for controlling the polarization. Furthermore, an array of the sensor recording the hologram does not have to be provided with an element that can distinguish the two object light beams, such as a polarizer and a color filter. Accordingly, three-dimensional data can be acquired with a simpler configuration. FIG. 4A is only an example of the image capturing apparatus using the digital holography, and instead of the aperture stop 521 as a mechanism for forming the plurality of object light beams, a plurality of galvanometer mirror (galvano mirror) can be used. Alternatively, the plurality of object light beams may be formed by other methods.

A shape of the aperture stop 521 for forming the illumination shape corresponds to each of (34,0) degree and (34,90) degree as the angle (θ,φ) of the beam, and it also corresponds to the real image spectra 432 and 433 of FIG. 3C. Hereinafter, the position of the crosstalk will be described with reference to the shape of the aperture stop 521 for forming the illumination shape. FIG. 4B illustrates the position of the real image spectrum, and it corresponds to the aperture stop 521 that forms the illumination shape. FIG. 4C illustrates the position of the virtual image spectrum, and it is obtained by rotating FIG. 4B around the origin by 180 degrees. FIG. 4D is autocorrelation of FIG. 4B, and it means the position of the spectrum of the crosstalk. FIG. 4E illustrates a sum of FIGS. 4B to 4D.

As described above, in order to extract the real image spectrum, it is desirable that the real image spectrum is separated from each of the virtual image spectrum and the spectrum caused by the crosstalk. In view of the description of the combination of the plurality of object light beams using the autocorrelation, it is desirable that the combination of the object light beams is selected so that the real image spectrum does not overlap with the autocorrelation of the real image spectrum. In more detail, it is necessary to determine the combination of the object light beams so that at least a distance from a center position of each real image spectrum to a center position of each spectrum obtained by the autocorrelation of the real image spectrum is longer than a radius of a simulated aperture stop that extracts the real image spectrum. The simulated aperture stop means an aperture stop which is set by simulation on the computer for extracting the real image spectrum from spectra.

### Embodiment 1

Next, Embodiment 1 of the present invention will be described. In this embodiment, as an example of a configuration that controls a position of crosstalk occurring due to interference of a plurality of object light beams, a configuration that controls a position of a spectrum of the crosstalk to be located at a position different from a position of a real image spectrum of each of the plurality of object light beams will be described. Specifically, a configuration that controls the spectrum of the crosstalk to be kept away from the vicinity of the center of a frequency space where the real image spectrum exists will be described.

In order to keep the spectrum of the crosstalk away from the vicinity of the center of the frequency space where the real image spectrum exists, an angle between a position vector of the real image spectrum of an object light beam and an inverse vector of a position vector of the real image spectrum of another object light beam only needs to be small. In order to achieve this, an angle between the plurality of object light beams only needs to be set to a large angle. The large angle means for example an angle larger than 90 degrees as an azimuth angle φ. However, when the angle is too large, for example 180 degrees, the real image spectrum of an object light beam overlaps with the virtual image spectrum of another object light beam, and therefore it is difficult to extract the real image spectrum of the object light beam. Accordingly, it is preferred that a range of the azimuth angle φ is larger than 90 degrees and is smaller than 150 degrees (90 to 150 degrees).

The combination of the angles of the plurality of object light beams is not only a condition on two pairs of object light beams, but also a condition that is applied to more object light beams. For example, when the azimuth angle φ of the first object light beam is set to 0 degree, a combination where the azimuth angle φ of the second object light beam is set to an angle that is larger than 90 degrees and is smaller than 150 degrees and the azimuth angle φ of the third object light beam is set to an angle that is larger than −150 degrees and is smaller than −90 degrees is considered. More specifically, for example, as azimuth angles φ of the three object light beams, 0, 120, and 240 degrees are considered. In this case, with respect to any of the combinations of the object light beams, the angles are satisfied so that a difference of the azimuth angles φ is larger than 90 degrees and is smaller than 150 degrees.

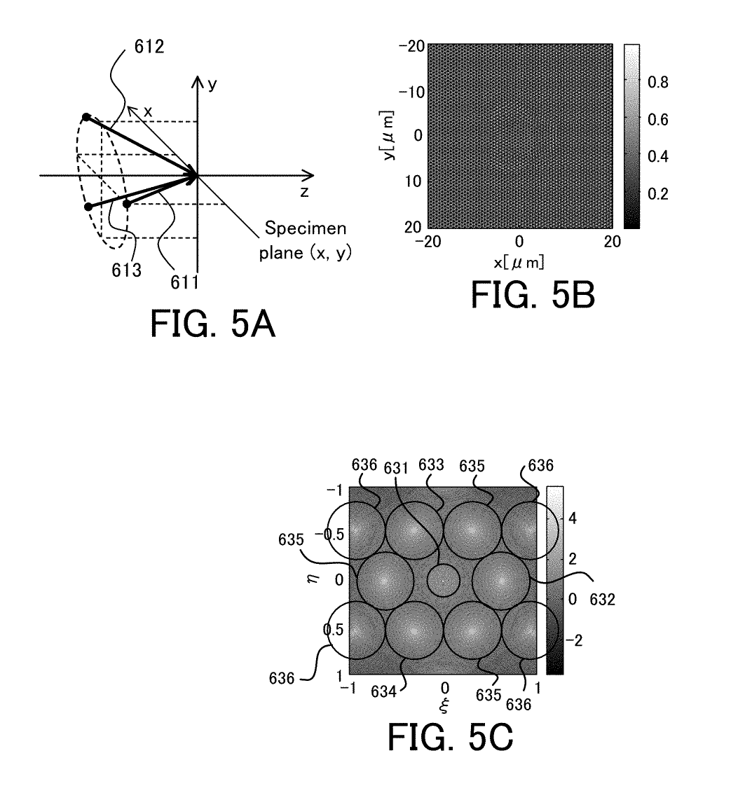

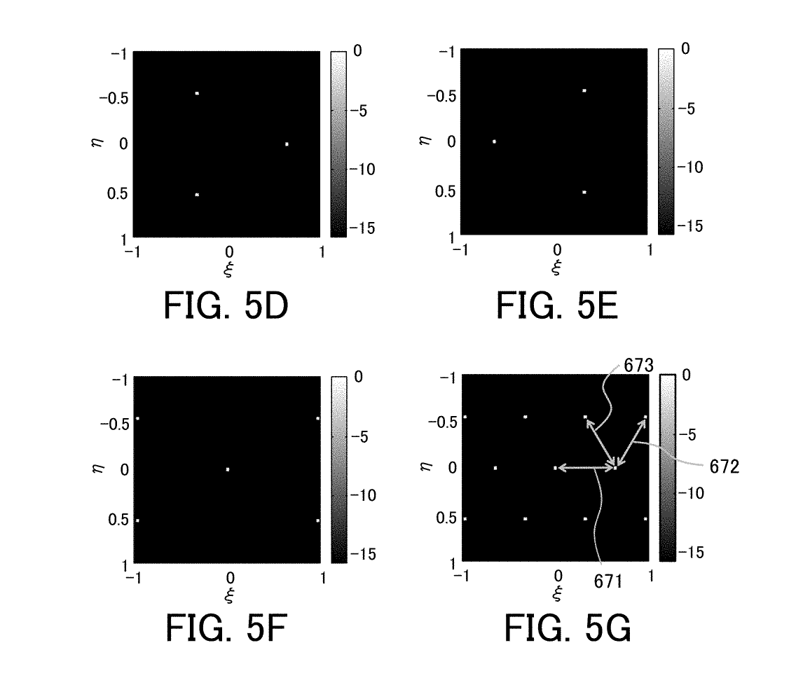

FIGS. 5A to 5G are explanatory diagrams of three object light beams that are simultaneously incident on the specimen, and they are diagrams relating to a configuration where the azimuth angles φ of the three object light beams are 0, 120, and 240 degrees. FIG. 5A illustrates the three object light beams that are simultaneously incident on a surface of the specimen. Reference numeral 611 denotes a first object light beam with the azimuth angle φ of 0 degree, reference numeral 612 denotes a second object light beam with the azimuth angle φ of 120 degrees, and reference numeral 613 denotes a third object light beam with the azimuth angle φ of 240 degrees. FIG. 5B illustrates a hologram that is obtained when the three object light beams illustrated in FIG. 5A are simultaneously incident. The reference light beam 212 is perpendicular to the digital sensor 208. FIG. 5C illustrates a spectrum of the hologram of FIG. 5B. Reference numeral 631 denotes a zeroth order light beam of the hologram, reference numeral 632 denotes a real image spectrum of the first object light beam 611, reference numeral 633 denotes a real image spectrum of the second object light beam 612, reference numeral 634 denotes a real image spectrum of the third object light beam 613, reference numeral 635 denotes a virtual image spectrum of the object light beam, and reference numeral 636 denotes a spectrum of the crosstalk. There are two crosstalks in addition to the four crosstalks 636. However, these two crosstalks are located outside a display area in upward and downward directions, and accordingly they are not illustrated in the drawing.

As described above, in this embodiment, the angle between the position vector of the real image spectrum of an object light beam and the position vector of the real image spectrum of another object light beam is set to an angle that is larger than 90 degrees and that is smaller than 150 degrees. As a result, the spectrum of the crosstalk can be kept away from the area of the real image spectrum. Furthermore, the plurality of real image spectra do not overlap with each other, and the real image spectrum and the virtual image spectrum do not overlap with each other. The term “do not overlap with each other” means that main components of the respective spectra do not overlap with each other, and at least the zeroth order light components of the respective real image spectra may not overlap with each other.

FIG. 5D illustrates positions of the real image spectra when the azimuth angles φ of the three object light beams are 0, 120, and 240 degrees. FIG. 5E illustrates positions of the virtual image spectra. FIG. 5F illustrates positions of the spectra of the crosstalks, which are calculated by autocorrelation of FIG. 5D. As can be seen in the drawing, the angle between the position vector of the real image spectrum of an object light beam and the position vector of the real image spectrum of another object light beam is set to an angle that is larger than 90 degrees and that is smaller than 150 degrees, and as a result the spectrum of the crosstalk is kept away from the area of the real image spectrum. FIG. 5G illustrates a sum of the spectra of FIGS. 5D to 5F, and it corresponds to FIG. 5C. A distance 672 from the real image spectrum to the spectrum of the crosstalk is not shorter than a distance 671 from the real image spectrum to the zeroth order light beam of the hologram. A distance 673 from the real image spectrum to the virtual image spectrum is not shorter than the distance 671 from the real image spectrum to the zeroth order light beam of the hologram. Accordingly, when the azimuth angles φ of the three object light beams are set to 0, 120, and 240 degrees, it is not necessary to reduce in size of a diameter of the simulated aperture stop that extracts the real image spectra even when the plurality of object light beams are simultaneously incident. The diameter of the simulated aperture stop corresponds to NA that determines a resolving power, and accordingly it means that the resolving power is not degraded even when multiplexing is performed by the object light beams that interfere with each other.

In order to obtain a high-quality three-dimensional reproduced image, a large number of object light beams are required. In this embodiment, as an example, it is assumed that 120 object light beams are required. When the plurality of object light beams are not simultaneously incident, as a typical example, the azimuth angle φ may be set to 0 degree for 1st photography, 3 degrees for 2nd photography, . . . , and 357 degrees for 120th photography. When the combination of the object light beams described in this embodiment is used, the angle may be set to 0, 120, and 240 degrees for 1st photography, 3, 123, and 243 degrees for 2nd photography, . . . , and 117, 237, and 357 degrees for 40th photography. While a conventional apparatus needs photography (tomography) 120 times when applying the 120 object light beams, this embodiment can reduce the number of photographing times (image capturing times) to 40 times.

For the 1st photography, the distribution of FIG. 5D may be set as the aperture stop 521 that forms the illumination shape. For the 2nd photography, the aperture stop 521 may be rotated by 3 degrees. Thus, by rotating the aperture stop 521, it is possible to generate 40 holograms without using a plurality of aperture stops.

Next, a way of calculation of the reproduced image will be described. Based on the spectrum of the hologram that is obtained by the 1st photography illustrated in FIG. 5C, the real image spectrum corresponding to the three object light beams can be extracted. Specifically, the 1st spectrum, the 2nd spectrum, and the 3rd spectrum correspond to the azimuth angles φ of 0, 120, and 240 degrees, respectively. Similarly, the spectra corresponding to the three object light beams are also extracted from the spectra of the holograms obtained by 2nd photography to 40th photography. As a result, the spectra corresponding to the azimuth angles φ of 0, 3, . . . , 357 degrees are extracted. By attaching the 120 spectra to the Ewald spheres illustrated in FIG. 2F, three-dimensional spectrum can be obtained. Alternatively, a logarithm of the electric field obtained by the inverse Fourier transform is calculated to attach its spectral data to the Ewald sphere, and thus the three-dimensional spectrum can be obtained. By performing the inverse Fourier transform of the three-dimensional spectrum, the three-dimensional reproduced image can be obtained. As described above, the real image spectra of the plurality of object light beams that are simultaneously incident can be individually extracted by the simulated aperture stop to perform calculation for reproduction (generation) of a three-dimensional image based on real image spectra of all object light beams.

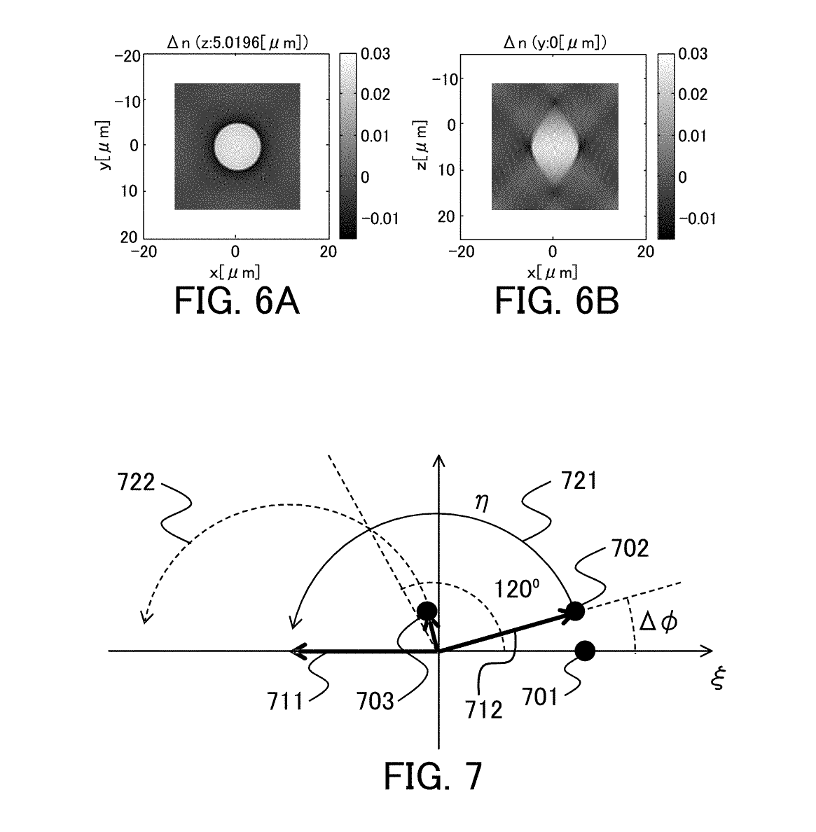

FIGS. 6A and 6B illustrate an XY cross-sectional view and an XZ cross-sectional view of the three-dimensional reproduced image, respectively. The size of the diameter of the simulated aperture stop is not reduced in multiplexing the incident light, and accordingly they can obtain an image quality similar to FIGS. 2G and 2H.

In this embodiment, the reference light beam is perpendicular to the sensor. Alternatively, the reference light beam may be incident obliquely on the sensor. When the reference light beam is inclined with respect to the sensor, the spectrum of the crosstalk does not move although the real image spectrum is kept away from the origin of the frequency space, and accordingly it is possible to apply a larger number of object light beams simultaneously. Hereinafter, this will be described referring to expressions.

When the reference light beam is incident obliquely with respect to the sensor, an electric field E_{R} of the reference light beam is represented by expression (11) below.

E_{R}(x,y)=2A_{R}exp[2πixα_{R}] (11)

For a simple description, it is assumed that the reference light beam is inclined with respect to an x direction. When the spectrum of the hologram is calculated by using the electric field E_{R} of expression (11), expression (12) below is obtained.

$$\int {\vert {E}_{O 1} + {E}_{O 2} + {E}_{R} \vert}^{2} exp [ - 2 π i ( x ξ + y η ) ] dxdy = \{ 8 π {A}_{R}^{2} δ ( ξ ) δ ( η ) + 2 π {\tilde{E}}_{O 1} ( ξ , η ) ⋆ {\tilde{E}}_{O 1} ( ξ , η ) + 2 π {\tilde{E}}_{O 2} ( ξ , η ) ⋆ {\tilde{E}}_{O 2} ( ξ , η ) \} + 4 π {A}_{R} {\tilde{E}}_{O 1} ( ξ - α + {α}_{R} , η ) + 4 π {A}_{R} {\tilde{E}}_{O 2} ( ξ + {α}_{R} , π - α ) + 4 π {A}_{R} {{E}^{\overline{\sim}}}_{O 1} ( - ξ + α - {α}_{R} , - η ) + 4 π {A}_{R} {{E}^{\overline{\sim}}}_{O 2} ( - ξ - {α}_{R} , - η + α ) + 2 π {\tilde{E}}_{O 1} ⋆ {\tilde{E}}_{O 2} ( ξ + α , η - α ) + 2 π {{E}^{\overline{\sim}}}_{O 1} ⋆ {{E}^{\overline{\sim}}}_{O 2} ( - ξ - α , - η + α ) \qquad ( 12 )$$

According to the second term and the third term of expression (12), it is understood that the real image spectrum is shifted by ξ=−αR due to the inclination of the reference light beam. On the other hand, according to the sixth term and the seventh term of expression (12), the spectrum of the crosstalk is not changed by the inclination of the reference light beam.

### Embodiment 2

Next, Embodiment 2 of the present invention will be described. In this embodiment, as an example of a configuration that controls a position of crosstalk occurring due to interference of a plurality of object light beams, a configuration that controls spectra of crosstalks to be collected into a predetermined region (partial region in a frequency space) will be described.

In order to collect the spectra of the crosstalks in the partial region of the frequency space, an angle between a position vector of a real image spectrum of an object light beam and an inverse vector of a position vector of a real image spectrum of another object light beam only has to be large. In order to achieve this, an angle of a plurality of object light beams may be small, and an azimuth angle φ may be within a certain range.

Referring to FIG. 7, the range of the azimuth angle φ will be described. FIG. 7 illustrates a position 701 of the real image spectrum of the first object light beam, a position 702 of the real image spectrum of the second object light beam, and a position 703 of the spectrum of the crosstalk. Symbol Δφ denotes an angle between the position vectors of the real image spectra. The position 703 of the spectrum of the crosstalk is determined by a vector sum of an inverse vector 711 of the position vector of the real image spectrum of the first object light beam and the real image spectrum 712 of the second object light beam. When the second object light beam is moved along a solid-line arrow 721 while the first object light beam is fixed, the position of the spectrum of the crosstalk moves along a dashed-line arrow 722. The solid-line arrow 721 and the dashed-line arrow 722 intersect at φ=120 degrees. Accordingly, it is preferred that the range of the azimuth angle φ is smaller than 120 degrees, i.e., Δφ<120. Since real image spectra of object light beams spread, it needs to consider a finite size of the simulated aperture stop. Therefore, in order to obtain a certain degree of resolution, the small angle may not be around 119 degrees, but may be around 110 degrees.

While the case where the two object light beams are simultaneously incident are described in this embodiment, many object light beams can be simultaneously incident as long as the center of an adjacent real image spectrum is not included in the simulated aperture stop. When the real image spectrum is close to the spectrum of the crosstalk, a diameter of the simulated aperture stop which extracts a real image spectrum closest to the crosstalk can be set to be smaller than a diameter of the simulated aperture stop which extracts another real image spectrum.

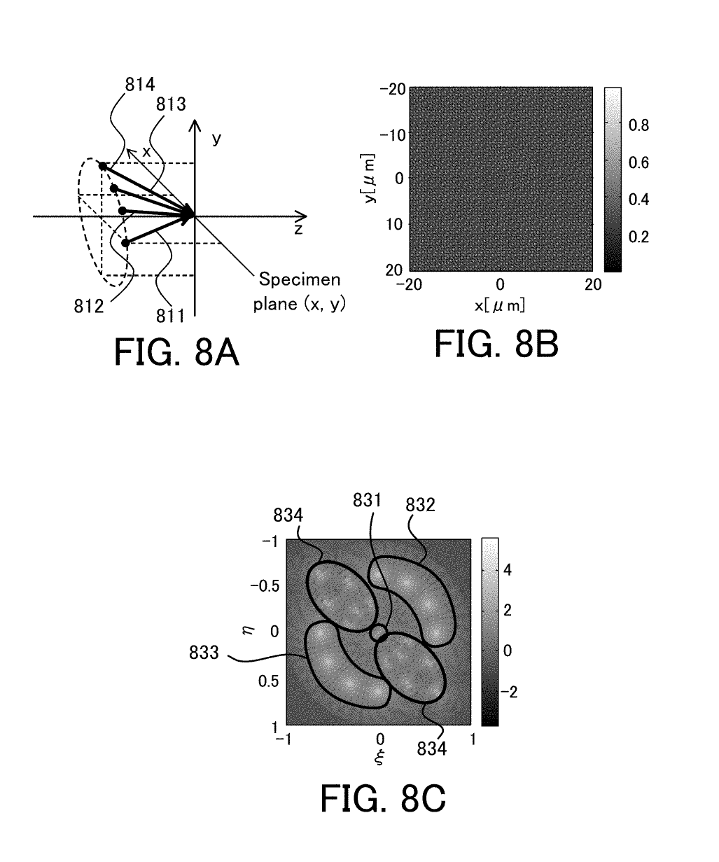

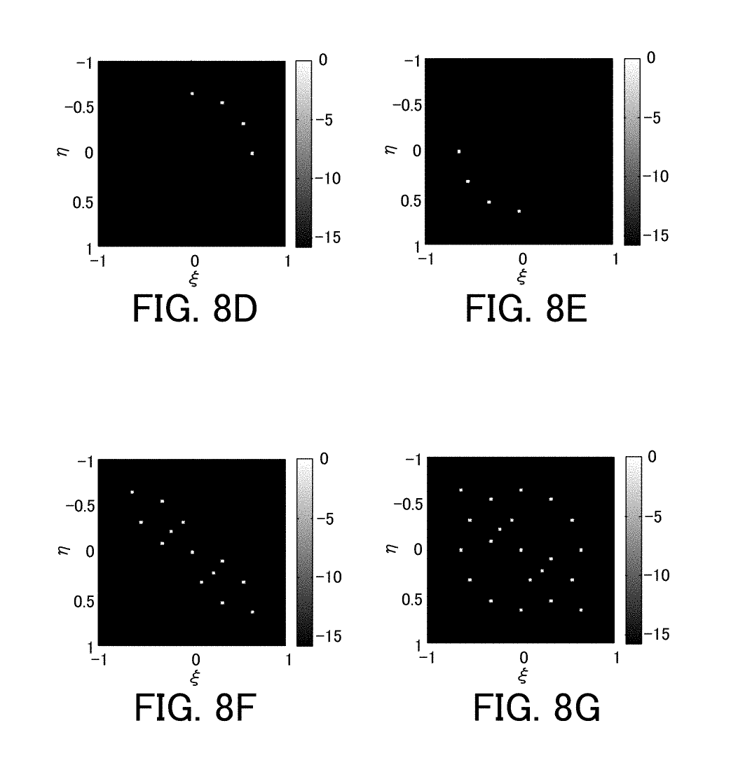

FIGS. 8A to 8G are explanatory diagrams of a case where the azimuth angles φ of four object light beams are 0, 30, 60, and 90 degrees. While an angle smaller than 120 degrees as the small angle is described as described above, in this example, the azimuth angles φ of all the object light beams are within 90 degrees. FIG. 8A illustrates the four object light beams that are simultaneously incident on a surface of the specimen. Reference numeral 811 denotes a first object light beam with the azimuth angle φ of 0 degree, reference numeral 812 denotes a second object light beam with the azimuth angle φ of 30 degrees, reference numeral 813 denotes a third object light beam with the azimuth angle φ of 60 degrees, and reference numeral 814 denotes a fourth object light beam with the azimuth angle φ of 90 degrees. FIG. 8B illustrates a hologram that is obtained when the plurality of object light beams illustrated in FIG. 8A are simultaneously incident. FIG. 8C illustrates a spectrum of the hologram of FIG. 8B. Reference numeral 831 denotes a zeroth order light beam of the hologram, reference numeral 832 denotes real image spectra of the object light beams, reference numeral 833 denotes virtual image spectra of the object light beams, and reference numeral 834 denotes spectra of the crosstalks. As described above, the spectra 834 of the crosstalks are collected in a partial region of a frequency space by reducing a difference of angles of the azimuth angles φ of the object light beams. They are appropriately separated from the real image spectra 832 of the four object light beams. Furthermore, the plurality of real image spectra do not overlap with each other, and the real image spectrum and the virtual image spectrum do not overlap with each other. The term “do not overlap with each other” means that main components of the respective spectra do not overlap with each other, and at least the zeroth order light components of the respective real image spectra may not overlap with each other.

FIG. 8D illustrates positions of the real image spectra when the azimuth angles φ of the four object light beams are 0, 30, 60, and 90 degrees. FIG. 8E illustrates positions of the virtual image spectra. FIG. 8F illustrates positions of the spectra of the crosstalks, which are calculated by autocorrelation of FIG. 8D. As can be seen in the drawing, the spectra of the crosstalks are collected in the partial region of the frequency space by reducing the difference of the angle between the azimuth angles φ of the object light beams. FIG. 8G illustrates a sum of the spectra of FIGS. 8D to 8F, and it corresponds to FIG. 8C.

In order to obtain a high-quality three-dimensional reproduced image, a large number of object light beams are required. In this embodiment, as an example, it is assumed that 120 object light beams are required. When the plurality of object light beams are not simultaneously incident, as a typical example, the azimuth angle φ may be set to 0 degree for 1st photography, 3 degrees for 2nd photography, . . . , and 357 degrees for 120th photography. When the combination of the object light beams described in this embodiment is used, the angles may be set as follows:

for 1st photography, 0, 30, 60, and 90 degrees,

for 2nd photography, 3, 33, 63, and 93 degrees, . . . ,

for 10th photography, 27, 57, 87, and 117 degrees,

for 11th photography, 120, 150, 180, and 210 degrees,

for 12th photography, 123, 153, 183, and 213 degrees, . . . ,

for 20th photography, 147, 177, 207, and 237 degrees,

for 21st photography, 240, 270, 300, and 330 degrees,

for 22nd photography, 243, 273, 303, and 333 degrees, . . . ,

for 30th photography, 267, 297, 327, and 357 degrees.

While a conventional apparatus needs photography 120 times when applying the 120 object light beams, this embodiment can reduce the number of photographing times to 30 times.

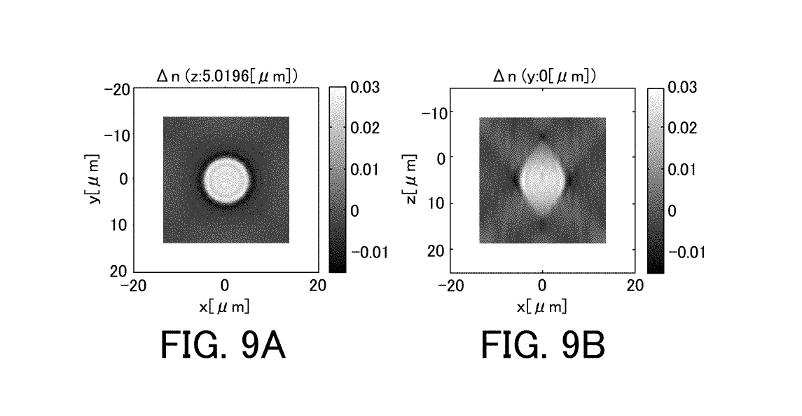

FIGS. 9A and 9B illustrate an XY cross-sectional view and an XZ cross-sectional view of the three-dimensional reproduced image, respectively. In this embodiment, the size of the diameter of the simulated aperture stop is reduced, and accordingly, a spatial high-frequency component is cut. However, with respect to the specimen of bead of 10 μm, a large amount of deterioration is not found.

### Embodiment 3

Next, Embodiment 3 of the present invention will be described. While Embodiment 2 describes the configuration of the image capturing apparatus using the plurality of object light beams with a single wavelength, this embodiment can acquire a number of wavefronts at the same time by overlap photography (overlap tomography) of the hologram by using the plurality of object light beams with different wavelengths or with different polarizations.

In this embodiment, the plurality of object light beams include a plurality of object light beams with different wavelengths from each other which are split from a plurality of light beams emitted from a plurality of light sources (first light source and second light source). The controller controls the plurality of object light beams with different wavelengths so as not to interfere with each other. In this embodiment, a case where overlap photography (overlap tomography) is performed on holograms by using a light source with light sources with different wavelengths of 543 nm and 553 nm (a plurality of light sources with different wavelengths) will be described. A specimen is polystyrene beads having a refractive index of 1.587 and a diameter of 10 μm that are immersed in oil having a refractive index of 1.575.

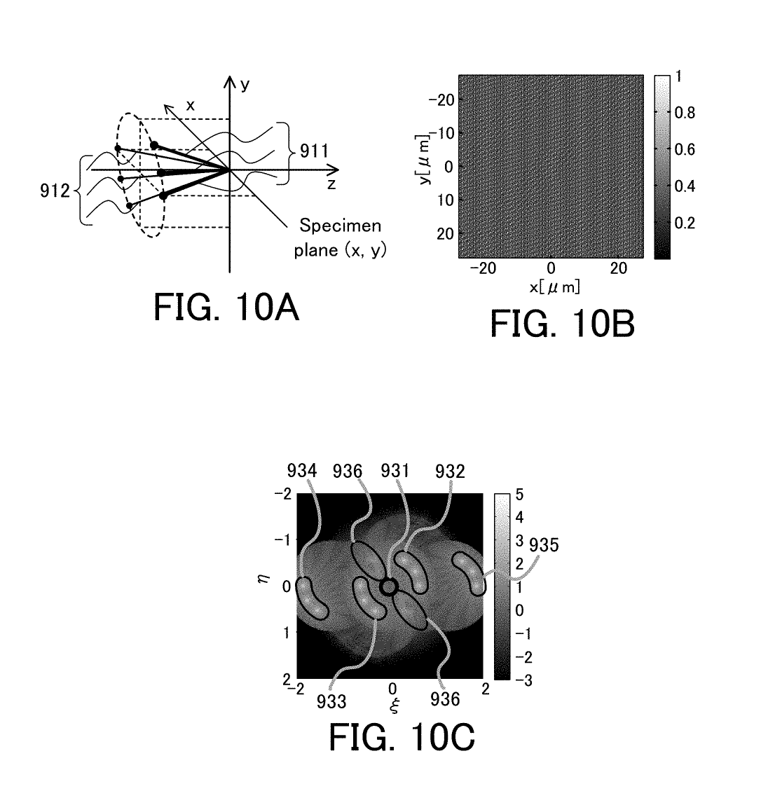

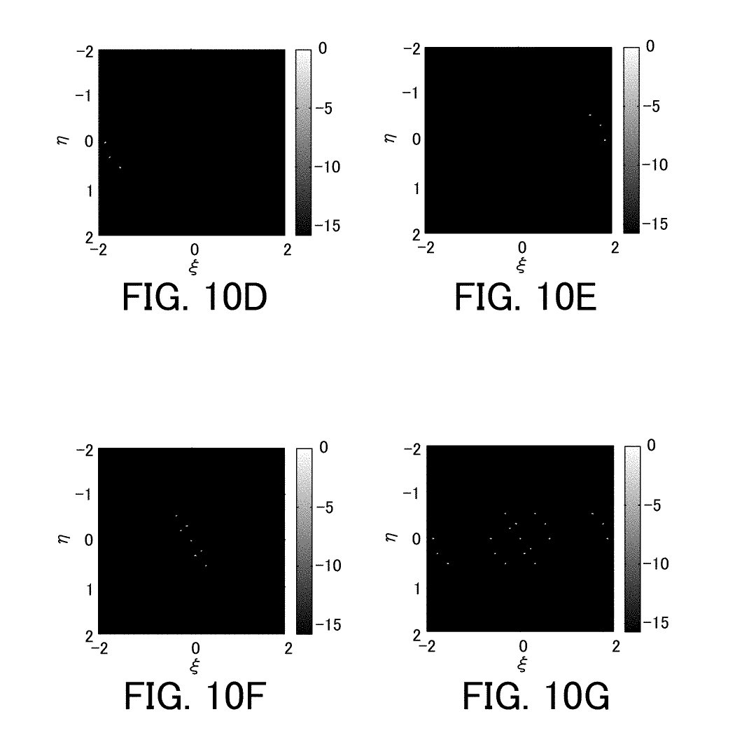

FIG. 10A illustrates a situation where the plurality of object light beams are simultaneously incident. Heavy lines 911 on a dotted-line circle towards the origin indicate the three object light beams (first object light beams) interfering with each other that are obtained by splitting the light beam with a wavelength of 543 nm, and these are incident on the specimen at angles (34, 0), (34, 30), and (34, 60) degrees, respectively. Thin lines 912 on the dotted-line circle towards the origin indicate the three object light beams (second object light beams) interfering with each other obtained by splitting the light beam with a wavelength of 553 nm, and they are incident on the specimen at angles (34,180), (34,210), and (34,240), respectively. These object light beams are controlled to interfere with a reference light beam on a sensor surface to acquire the hologram.

FIG. 10B illustrates a hologram that is obtained when a first reference light beam that is obtained by splitting the light beam having the wavelength of 543 nm is incident perpendicularly to the sensor surface and a second reference light beam that is obtained by splitting the light beam having the wavelength of 553 nm is incident obliquely to the sensor surface at an angle of (10,0). A magnification b of an image capturing optical system is set to 10. FIG. 10C illustrates a spectrum that is obtained by the Fourier transform of this hologram. This spectrum includes a zeroth order light beam 931 of the hologram, a real image spectrum 932 of the first object light beams, a virtual image spectrum 933 of the first object light beams, a real image spectrum 934 of the second object light beams, a virtual image spectrum 935 of the second object light beams, and a crosstalk 936. The real image spectrum of the first object light beams and the real image spectrum of the second object light beams do not overlap with the crosstalk and the virtual image spectrum, and accordingly each wavefront can be extracted by separating these spectra.

FIG. 10D illustrates a position of the real image spectrum corresponding to the second object light beams. FIG. 10E illustrates a position of the virtual image spectrum, and FIG. 10F illustrates a position of the spectrum of the crosstalk calculated by autocorrelation of FIG. 10D. Even when the reference light beam is obliquely incident, the crosstalk can be collected in a partial region of the frequency space by decreasing the angle between position vectors of the real image spectra. Furthermore, the position of the crosstalk appears at the same position as that in FIG. 8F. This can be explained as follows.

In this embodiment, the first object light beams and the second object light beams are incident in directions symmetric with respect to the optical axis. The direction symmetric with respect to the optical axis corresponds to replacing α and β, with −α and −β in expression (1), respectively. In this case, the fifth term of expression (7) that represents the spectrum of the crosstalk is changed as expression (13) below.

$${\sum }_{j = 1}^{N} {\tilde{E}}_{Oj} ⋆ {\sum }_{{j}^{′} \neq j}^{N} {\tilde{E}}_{{Oj}^{′}} ( ξ - {α}_{j} + {α}_{{j}^{′}} , η - {β}_{j} + {β}_{{j}^{′}} ) \qquad ( 13 )$$

This means that the spectrum of the crosstalk occurs at the position of (αj-αj′, βj-βj′), and it is the same as the position of the spectrum of the crosstalk that is represented by the seventh term of expression (7). In other words, if the first object light beams and the second object light beams are incident in the directions symmetric with respect to the optical axis, it is possible to collect the spectra of the crosstalks at the same position. By adopting this arrangement, a region that the spectra of the crosstalks occupy can be minimized. The first object light beams and the second object light beams are not necessarily incident in strictly symmetric directions, but an incident direction can be determined within a range where the real image spectrum does not roughly overlap with the spectrum of the crosstalk. FIG. 10G illustrates a sum of the spectra of FIGS. 10D to 10F, and it corresponds to FIG. 10C.

In order to obtain a high-quality three-dimensional reproduced image, similarly to Embodiment 2, 120 object light beams are required. When the combination of the object light beams described in this embodiment is used, the azimuth angle of each object light beam may be set as follows:

for 1st photography, 0, 30, and 60 degrees with respect to the first object light beams, and 180, 210, and 240 degrees with respect to the second object light beams,

for 2nd photography, 3, 33, and 63 with respect to the first object light beams, and 183, 213, and 243 degrees with respect to the second object light beams, . . . ,

for 10th photography, 27, 57, and 87 degrees with respect to the first object light beams, and 207, 237, and 267 degrees with respect to the second object light beams,

for 11th photography, 270, 300, and 330 degrees with respect to the first object light beams, and 90, 120, and 150 degrees with respect to the second object light beams,

for 12th photography, 273, 303, and 333 degrees with respect to the first object light beams, and 93, 123, and 153 degrees with respect to the second object light beams, . . . ,

for 20th photography, 297, 327, and 357 degrees with respect to the first object light beams, and 117, 147, and 177 degrees with respect to the second object light beams,

While a conventional apparatus needs photography 120 times for acquiring the 120 object light beams, this embodiment can reduce the number of photographing times to 20 times.

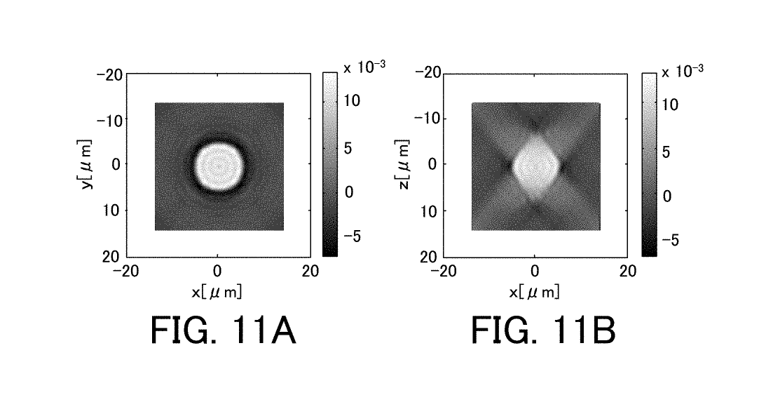

FIGS. 11A and 11B illustrate an XY cross-sectional view and an XZ cross-sectional view of the three-dimensional reproduced image, respectively. In this embodiment, the size of the diameter of the simulated aperture stop is reduced, and accordingly, a spatial high-frequency component is cut. However, with respect to the specimen of bead of 10 μm, a large amount of deterioration is not found.

In this embodiment, it is preferred that an azimuth angle of the second object light beams is set to be within a range from +90 degrees to +270 degrees with respect to the azimuth angle of the second reference light beam. In other words, the reference light beam and the plurality of object light beams that are obtained based on a light beam emitted from at least one of the plurality of light sources are incident on the digital sensor (image sensor) at azimuth angles φ_{R} and φ, respectively, and it is preferred that the azimuth angles φ_{R} and φ satisfy a condition of φ_{R}+90°≦φ≦φ_{R}+270°. In this range, the second reference light beam and the second object light beams are incident on the sensor in directions roughly symmetric with respect to the optical axis, and accordingly the real image spectrum of the second object light beams can be kept away from the origin. As a result, the overlap with the real image spectrum, the virtual image spectrum, and the spectrum of the crosstalk can be avoided.

In this embodiment, the second reference light beam is obliquely incident on the sensor. In this case, the real image spectrum of the second object light beams moves in a region different from the position indicated by a solid-line arrow 721 of FIG. 7. As a result, an angle Δφ₂ between the position vectors of the real image spectra of the second object light beams (i.e., (a maximum value of) a difference of the azimuth angles of the plurality of object light beams split from a light beam emitted from the second light source) indicates a value different from 120 degrees.

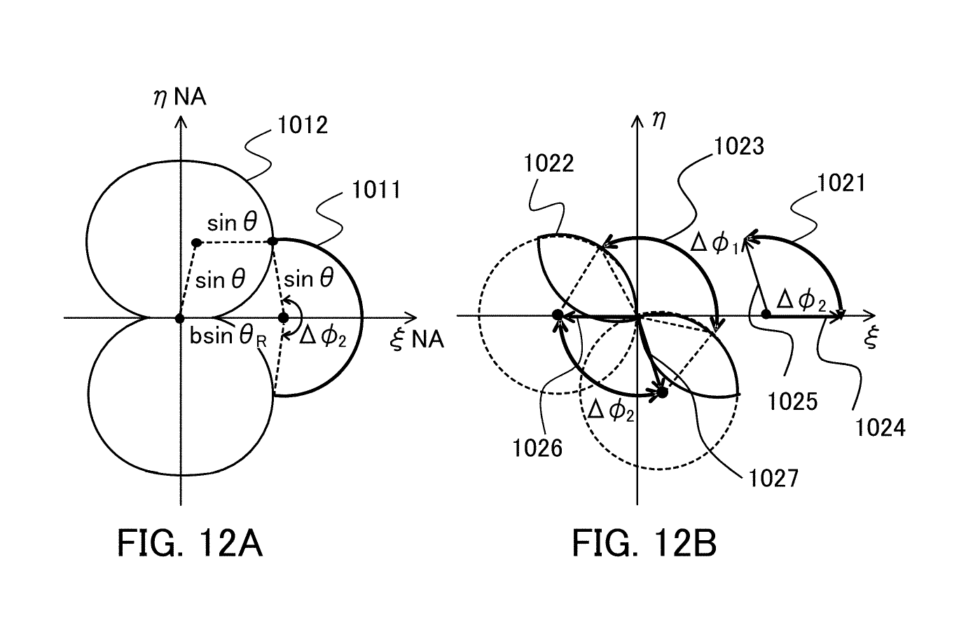

Referring to FIG. 12A, a method of obtaining a maximum value of Δφ₂ will be described. For simple descriptions, a case where φ_{R}=0 is satisfied is considered. When the reference light beam is obliquely incident, the center of a circle where the real image spectrum moves is shifted to ξNA=b·sin θ_{R} (region 1011 in FIG. 12A (inside a heavy line)). In order to consider a region where the spectrum of the crosstalk occurs, it is assumed that the object light beams exist in the entire black region. In this case, since a function that does not indicate zero in this black region is denoted by S (ξ,η), the spectrum of the crosstalk is located in a region where autocorrelation of this function does not indicate zero (region 1012 in FIG. 12A (inside a thin line)). In order to avoid overlapping the real image spectrum with the spectrum of the crosstalk, the region 1011 and the region 1012 may not include a common region. When the region 1011 and the region 1012 are in contact with each other, the region 1011 is widest. According to the geometric considerations, it is preferred that (a maximum value of) a difference Δφ₂ between the azimuth angles of the respective object light beams in the object light beams satisfies expression (14) below.

$$\vert Δ {φ}_{2} \vert \leq 180 ° + arcsin ( \frac{sin {θ}_{R} - sin θ}{2 sin θ} ) \qquad ( 14 )$$

When the condition represented by expression (14) is satisfied, the overlap of the spectrum of the crosstalk and the real image spectrum can be avoided.

Furthermore, there is a condition relating to an angle Δφ₁ between the position vectors of the real image spectra of the first object light beams (i.e., (maximum value of) a difference between the azimuth angles of the plurality of object light beams split from a light beam emitted from the first light source) and an angle Δφ₂ between the position vectors of the real image spectra of the second object light beams (i.e., (maximum value of) a difference between the position vectors of the real image spectra of the second object light beams). This will be described referring to FIG. 10B. When it is assumed that the real image spectra of the second object light beams move in a region 1021, a region where the crosstalk occurs is in a region surrounded by a thin line 1022. A region 1023 where the real image spectrum of the first object light beams move is in contact with the region 1022, the angle Δφ₁ is maximized. It is preferred that |Δφ1|≦120° is satisfied. According to the property of the autocorrelation, a boundary line where the region 1022 and the region 1023 are in contact with each other in the second quadrant is a circle centered at an inverse vector 1026 of a vector 1024. Furthermore, a boundary line where the region 1022 and the region 1023 are in contact with each other in the fourth quadrant is a circle centered at an inverse vector 1027 of a vector 1025. According to these conditions, in geometric considerations, the relational expression between Δφ₁ and Δφ₂ is represented by expression (15) below.

|Δφ₁|≦240°−|Δφ₂| (15)

When the angles Δφ₁ and Δφ₂ are determined so as to satisfy expression (15), the overlap of the spectrum of the crosstalk and the real image spectrum can be avoided.

In this embodiment, functions that do not indicate zero at a position of a spatial frequency f of the zeroth order light component of m-th, m′-th, and j-th real image spectra of the plurality of object light beams are denoted by Sm(f), Sm′ (f), and Sj(f), and cross-correlation is denoted by *. Then, conditional expressions of (A):|Sm(f)|>0, (B):|Sm′(f)|>0 (m′=1˜M, m≠m′), (C):|Sm′(f)*Sj(f)|>0 (m′=1˜M, j=1˜M), and (D):|Sm′(−f)|>0 (m′=1˜M) are considered. In this case, it is preferred that a solution that simultaneously satisfies a condition of expressions (A) and (B), a condition of expressions (A) and (C), and a condition of expressions (A) and (D) does not exist.

While this embodiment uses light beams with a plurality of wavelengths, it is not limited thereto. As long as a plurality of light beams that do not interfere with each other is used, it is possible to obtain an effect similar to this embodiment. For example, two light beams with linear polarization where polarization directions are orthogonal to each other may be used.

In each embodiment, as angles of the object light beams, the combination of the plurality of azimuth angles φ while fixing the angle θ with respect to the optical axis is described, and alternatively a combination of the angles θ with respect to a plurality of optical axes while fixing the azimuth angle φ may be used. Combinations of both the angles θ with respect to the optical axes and the azimuth angles φ can also be used.

According to each embodiment, an image capturing apparatus and an image capturing method that are capable of acquiring highly-accurate three-dimensional data with a simple configuration and by a small number of photographing times can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-002702, filed on Jan. 8, 2016, which is hereby incorporated by reference herein in its entirety.

What is claimed is:

1. An image capturing apparatus capable of performing three-dimensional tomography of an object by digital holography, the image capturing apparatus comprising:
a splitting element configured to split a light beam emitted from a light source into an object light beam and a reference light beam;
an illumination system configured to control a plurality of object light beams that are generated from the object light beam and that move in directions different from each other to be incident on the object simultaneously;
a composite element configured to cause the plurality of object light beams to interfere with the reference light beam;
an image sensor configured to acquire hologram generated by interference of each of the plurality of light beams with the reference light beam; and
a controller configured to control the illumination system so that the plurality of object light beams interfere with each other on the image sensor.

2. The image capturing apparatus according to claim 1, wherein the illumination system includes an aperture stop configured to separate the object light beam into the plurality of light beams.

3. The image capturing apparatus according to claim 1, wherein the illumination system includes a plurality of galvano mirrors that separate the object light beam into the plurality of object light beams.

4. The image capturing apparatus according to claim 1, wherein the plurality of object light beams have a single wavelength.

5. The image capturing apparatus according to claim 1, wherein the controller is configured to control a position of crosstalk that is generated by interference of the plurality of object light beams.

6. The image capturing apparatus according to claim 5, wherein the controller is configured to control a position of a spectrum of the crosstalk to be a position different from a real image spectrum of each of the plurality of object light beams, the spectrum being a distribution on a frequency space obtained by Fourier transform of the hologram.

7. The image capturing apparatus according to claim 5, wherein the controller is configured to control a spectrum of the crosstalk to be collected into a predetermined region, the spectrum being a distribution on a frequency space obtained by Fourier transform of the hologram.

8. The image capturing apparatus according to claim 1, wherein the controller is configured to set angles of the plurality of object light beams with respect to the object so that a zeroth order light component of a real image spectrum and a zeroth order light component of a virtual image spectrum of each of the plurality of object light beams do not overlap with each other, the spectrum being a distribution on a frequency space obtained by Fourier transform of the hologram.

9. The image capturing apparatus according to claim 1, wherein a solution that simultaneously satisfies conditions below does not exist:

|S(f)|>0, and

|S(f)*S(f)|>0,
where symbol S(f) is a function that does not indicate zero at a position of a spatial frequency f of a zeroth order light component of a real image spectrum, and symbol * is cross-correlation, the spectrum being a distribution on a frequency space obtained by Fourier transform of the hologram.

10. The image capturing apparatus according to claim 9, wherein when an angle of each of the plurality of object light beams with respect to the object is represented by using an angle θ with respect to an optical axis and an azimuth angle φ and an azimuth angle φ of a first object light beam of the plurality of object light beams is 0 degree, an azimuth angle φ of a second object light beam of the plurality of object light beams is 90 to 150 degrees.

11. The image capturing apparatus according to claim 9, wherein the azimuth angle φ of each of the plurality of object light beams is within a range smaller than 120 degrees.

12. The image capturing apparatus according to claim 1, wherein the image sensor is configured to generate a three-dimensional image of the object by using a real image spectrum of each of the plurality of object light beams.

13. The image capturing apparatus according to claim 1, wherein:
the plurality of object light beams include a plurality of object light beams that are split from a plurality of light beams emitted from a plurality of light sources and that have different wavelengths from each other, and
the controller is configured to control the plurality of object light beams having the different wavelengths so as not to interfere with each other.

14. The image capturing apparatus according to claim 13, wherein a solution that simultaneously satisfies a condition of expressions (A) and (B), a condition of expressions (A) and (C), and a condition of expressions (A) and (D) does not exist:

|Sm(f)|>0 (A):

|Sm′(f)|>0 (m′=1˜M,m≠m′) (B):

|Sm′(f)*Sj(f)|>0 (m′=1˜M,j=1˜M) (C):

|Sm′(−f)|>0 (m′=1˜M), (D):
where symbols Sm(f), Sm′ (f), and Sj(f) are functions that do not indicate zero at a position of a spatial frequency f of a zeroth order light component of m-th, m′-th, and j-th real image spectra of the plurality of object light beams, and symbol * is cross-correlation, the spectrum being a distribution on a frequency space obtained by Fourier transform of the hologram.

15. The image capturing apparatus according to claim 13, wherein:
the reference light beam and the plurality of object light beams that are obtained based on a light beam emitted from at least one of the plurality of light sources are incident on the image sensor at azimuth angles φ_{R} and φ, respectively, and
the azimuth angles φ_{R} and φ a satisfy a condition of φ_{R}+90°≦φ≦φ_{R}+270°.

16. The image capturing apparatus according to claim 13, wherein:
the plurality of light sources include a first light source and a second light source, and
conditions below are satisfied:
$$\begin{matrix}\vert Δ {φ}_{1} \vert \leq 120 ° \\ \vert Δ {φ}_{2} \vert \leq 180 ° + arcsin ( \frac{sin {θ}_{R} - sin θ}{2 sin θ} ) \\ \vert Δ {φ}_{1} \vert \leq {240}^{°} - \vert Δ {φ}_{2} \vert ,\end{matrix}$$
where symbol Δφ₁ is a difference of azimuth angles of the plurality of object light beams split from a light beam emitted from the first light source, symbol Δφ₂ is a difference of azimuth angles of the plurality of object light beams split from a light beam emitted from the second light source, and symbol θ_{R} is an angle of incidence of at least one of the reference light beams split from the light beams emitted from the first and second light sources on the image sensor with respect to an optical axis.

17. The image capturing apparatus according to claim 1, wherein the image capturing apparatus is configured to perform the three-dimensional tomography of the object by the digital holography using an Off-Axis method.

18. An image capture method capable of performing three-dimensional tomography of an object by digital holography, the method comprising the steps of:
splitting a light beam emitted from a light source into an object light beam and a reference light beam;
controlling a plurality of object light beams that are generated from the object light beam and that move in directions different from each other to be incident on the object simultaneously;
combining the plurality of object light beams with the reference light beam; and
acquiring hologram generated by interference of each of the plurality of light beams with the reference light beam,
wherein the step of controlling the plurality of object light beams to be incident on the object simultaneously includes controlling the plurality of object light beams to interfere with each other on an image sensor.
